(19) United States
(12) Patent Application Publication
(10) Pub. No.: US 2020/0130470 A1
(43) Pub. Date: Apr. 30, 2020

(54) VEHICLE

(71) Applicant: ISUZU MOTORS LIMITED, Shinagawa-ku, Tokyo (JP)

(72) Inventor: Toshiyuki NAITOU, Fujisawa-shi, Kanagawa (JP)

(21) Appl. No.: 16/622,780

(22) PCT Filed: Jun. 7, 2018
(86) PCT No.: PCT/JP2018/021862

§ 371 Date: Dec. 13, 2019

(30) Foreign Application Priority Data
Jun. 14, 2017 (JP) 2017-116628

(51) Int. Cl. B60H 1/24; B60J 5/04

(52) U.S. Cl. CPC B60H 1/249; B60H 1/243; B60J 5/0493

(57) ABSTRACT

A vehicle includes an openable door, a discharge port, a valve and a rotation mechanism. The discharge port communicates a vehicle cabin space with an outside, and discharges air in a vehicle cabin to the outside. The valve is rotatable between an open position for opening the discharge port and a closed position for closing the discharge port. The rotating mechanism couples the door with the valve such that the valve is rotated from the closed position to the open position when the door is opening, and rotated from the open position to the closed position when the door is closing. The rotating mechanism does not bring the valve being rotated from the open position to reach the closed position at a moment when the door is closed, and further rotates the valve to the closed position when the door is in a state of being closed.

### TECHNICAL FIELD

The present disclosure relates to a vehicle including a discharge port which discharges air in a vehicle cabin to the outside.

### BACKGROUND ART

Vehicles such as trucks are provided with openable doors such that occupants can get on and off a cabin. In addition, since the pressure in a vehicle cabin increases when the door is just closed, from the viewpoint of reducing the pressure in the vehicle cabin, the vehicle is provided with a rotatable one-way valve at a discharge port that communicates the vehicle cabin with the outside. When the door is closing, the one-way valve is pushed up, so that the air in the vehicle cabin is discharged to the outside via the discharge port, and as a result, the pressure is reduced.

### CITATION LIST

### Patent Document

Patent Literature 1: JP-1-102-83109-U

### SUMMARY OF THE INVENTION

### Technical Problem

However, since the above one-way valve has a configuration that can freely close and open the discharge port, for example, at a moment when the door is closed, the pressure in a vehicle cabin space increases and thus may cause fluttering. When the one-way valve flutters, there is a risk that abnormal noise (such as noise outside the vehicle) may enter the vehicle cabin via the discharge port.

An object of the present disclosure is to provide a vehicle which can prevent an abnormal noise from entering a vehicle cabin via a discharge port for pressure reduction of a vehicle cabin space.

### Solution to Problem

According to the present disclosure, there is provided a vehicle including:

an openable door;

a discharge port configured to communicate a vehicle cabin space with an outside, and to discharge air in a vehicle cabin to the outside;

a valve provided at the discharge port and rotatable between an open position for opening the discharge port and a closed position for closing the discharge port; and

a rotation mechanism coupling the door with the valve, configured to rotate the valve from the closed position to the open position when the door is opening, and configured to rotate the valve from the open position to the closed position when the door is closing,

in which the rotation mechanism does not bring the valve being rotated from the open position to the closed position at a moment when the door is closed, and further rotates the valve to the closed position when the door is in a state of being closed.

According to the vehicle having the above configuration, since the valve is not at the closed position at the moment when the door is closed, the discharge port is not closed by the valve, and the air in the vehicle cabin is discharged from the discharge port to the outside of the vehicle. Accordingly, at the moment when the door is closed, the pressure in the vehicle cabin space can be prevented from increasing. Thereafter, when the door is in a state of being closed, the discharge port is closed by the valve. Therefore, abnormal noise can be prevented from entering the vehicle cabin via the discharge port.

In addition, the valve may be rotated from the open position to the closed position by an urging force,

the rotation mechanism may include a damping member connected to the valve and configured to damp the urging force, and

the damping member may rotate, when the door is closing, the valve from the open position to the closed position after a time lag from a moment of the door just being closed.

In addition, the rotation mechanism may include an urging member configured to generate the urging force acting on the valve, and

the urging member may be connected to the valve at a portion near a rotation center of the valve, and the damping member may be connected to the valve at a portion away from the rotation center of the valve.

Further, the rotation mechanism may include a link member coupling the damping member with the door, and configured to move straight along a longitudinal direction of the damping member when the door is opening or closing to adjust a distance from the valve.

### Advantageous Effects of the Invention

According to the vehicle of the present disclosure, the abnormal noise can be prevented from entering the vehicle cabin via the discharge port for pressure reduction of the vehicle cabin space.

### BRIEF DESCRIPTION OF THE DRAWINGS

FIG. 1 is a diagram illustrating an example of a configuration of a vehicle according to an embodiment of the present disclosure.

FIG. 2 is a schematic diagram showing a state of a valve when a door is closed.

FIG. 3 is a schematic diagram showing a state of the valve when the door is open.

FIG. 4A is a schematic diagram illustrating a state of the valve when the door is closing.

FIG. 4B is a schematic diagram illustrating a state of the valve when the door is closing.

FIG. 4C is a schematic diagram illustrating a state of the valve when the door is closing.

### DESCRIPTION OF EMBODIMENTS

<Outline of Vehicle>

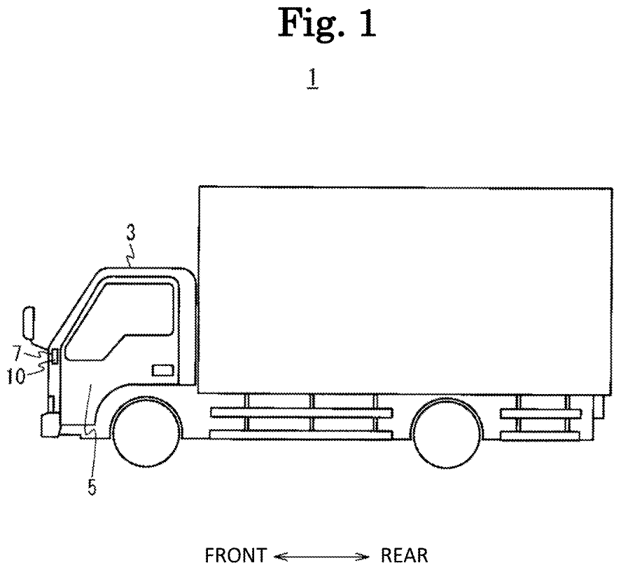

An outline of a vehicle 1 according to the present disclosure will be described with reference to FIG. 1.

FIG. 1 is a diagram illustrating an example of a configuration of a vehicle 1 according to an embodiment. The vehicle 1 is a vehicle including a frame structure having a vehicle body frame, and here is a truck. As shown in FIG. 1, the vehicle 1 includes a cabin 3, a door 5, a discharge port 7, and a valve 10.

The cabin 3 is disposed in the front of the vehicle 1 and forms a vehicle cabin in which an occupant such as a driver is seated. The cabin 3 is attached to the front of the vehicle body frame of the vehicle 1.

The door 5 is provided on a side surface of the cabin 3 so as to be openable and closable. The door 5 is opened and closed when the occupant gets on and off the cabin 3.

The discharge port 7 communicates a vehicle cabin space of the cabin 3 with the outside (external) of the vehicle. The discharge port 7 is an opening configured to discharge air in the vehicle cabin to the outside. When the door 5 is closed, the air in the vehicle cabin of the cabin 3 is discharged to the outside via the discharge port 7, so that the pressure in the vehicle cabin space is reduced.

The valve 10 is provided at the discharge port 7. The valve 10 rotates between a closed position for closing the discharge port 7 and an open position for opening the discharge port 7. In addition, the valve 10 rotates with the opening and closing of the door 5 by a rotation mechanism to be described later.

Generally, in the vehicle 1, since the inside of the cabin 3 is sealed at the moment when the door 5 is closed, the pressure in the cabin 3 increases. In the present embodiment, when the door 5 is closing, the pressure in the vehicle cabin space is reduced at the moment when the door 5 is closed by controlling a rotation state of the valve 10 that rotates with the opening and closing of the door 5.

<Valve Rotation Structure Working with Opening and Closing of Door>

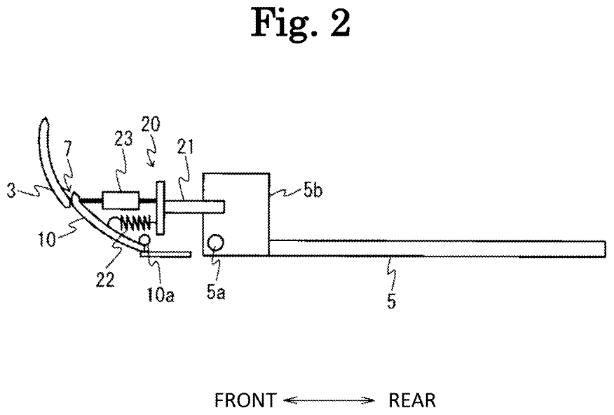

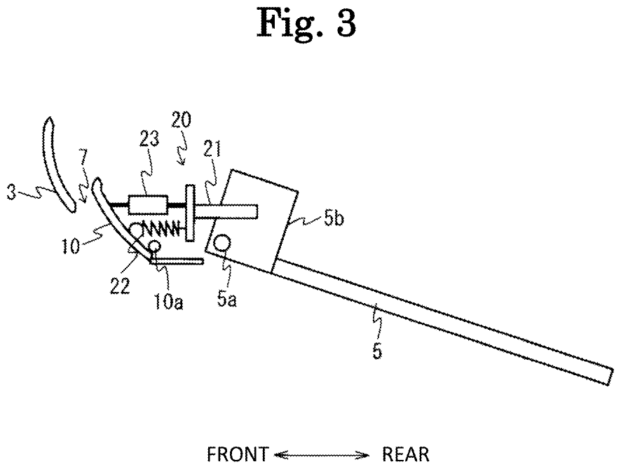

The configuration of the valve 10 that rotates with the opening and closing of the door 5 will be described with reference to FIG. 2 and FIG. 3. Hereinafter, although a configuration on a door 5 side of a pair of doors 5 provided in both surfaces of the cabin 3 is demonstrated, the configuration on the other door 5 side is also the same.

FIG. 2 is a schematic diagram showing a state of a valve 10 when the door 5 is closed. FIG. 3 is a schematic diagram showing a state of the valve 10 when the door 5 is open. FIG. 2 and FIG. 3 show the door 5 and the like when the cabin 3 is viewed from above.

As shown in FIG. 2 and FIG. 3, the door 5 rotates around a rotation shaft 5a. A connecting portion 5b connecting to a link member 21 of the rotation mechanism 20 is provided on a tip end side of the door 5.

The discharge port 7 is formed near the door 5 in the cabin 3. Specifically, as shown in FIG. 3, the discharge port 7 is formed in front of the door 5 on a side surface of the cabin 3.

The valve 10 rotates around a rotation shaft 10a. Specifically, the valve 10 rotates between a closed position tier closing the discharge port 7 as shown in FIG. 2 and an open position for opening the discharge port 7 as shown in FIG. 3. Here, the valve 10 is a check valve. When the valve 10 is at the closed position, the discharge port 7 is closed, so that the air in the vehicle cabin is not discharged to the outside. On the other hand, when the valve 10 is at the open position, the discharge port 7 is open, so that the air in the vehicle cabin is discharged to the outside the vehicle via the discharge port 7.

The rotation mechanism 20 is a coupling mechanism for coupling the door 5 with the valve 10. The rotation mechanism 20 rotates the valve 10 with the opening and closing of the door 5. Specifically, the rotation mechanism 20 rotates the valve 10 from the closed position to the open position when the door 5 is opening, and rotates the valve 10 from the open position to the closed position when the door 5 is closing.

In addition, the rotation mechanism 20 does not bring the valve 10 being rotated from the open position to the closed position at a moment when the door 5 is closed, and then further rotates the valve 10 to the closed position when the door 5 is in a state of being closed. Accordingly, at the moment when the door 5 is closed, the discharge port 7 is not closed by the valve 10 and the air in the vehicle cabin is discharged from the discharge port 7 to the outside of the vehicle. As a result, the pressure in the vehicle cabin space can be prevented from increasing at the moment when the door 5 is closed.

As shown in FIG. 2, the rotation mechanism 20 includes the link member 21, a spring member 22, and a damper 23.

The link member 21 is connected to the connecting portion 5b of the door 5. The link member 21 moves straight according to a rotation movement of the door 5 when the door 5 is opening or closing (see FIG. 2 and FIG. 3). The link member 21 adjusts a distance from the valve 10 by moving straight along a longitudinal direction of the spring member 22 or the damper 23.

The spring member 22 is provided behind the valve 10 and is an urging member configured to urge the valve 10. The spring member 22 is a compression spring, for example. One end in the longitudinal direction of the spring member 22 is connected to the valve 10, and the other end in the longitudinal direction of the spring member 22 is connected to the link member 21. An urging force of the spring member 22 is a force acting in a direction in which the valve 10 is rotated from the open position to the closed position. When the door 5 is closing, the valve 10 rotates to the closed position by the urging force of the spring member 22. Since the spring member 22 urges the valve 10, the valve 10 can be prevented from fluttering, for example, when the air passes through the discharge port 7.

The damper 23 is a damping member provided behind the valve 10 and configured to damp the urging force acting on the valve 10. Accordingly, the valve 10 urged by the spring member 22 slowly rotates from the open position to the closed position. For example, the damper 23 damps the urging force using oil flowing as a working fluid therein. One end in the longitudinal direction of the damper 23 is connected to the valve 10, and the other end in the longitudinal direction of the damper 23 is connected to the link member 21.

The damper 23 rotates, when the door 5 is closing, the valve 10 from the open position to the closed position after a time lag from a moment of the door 5 just being closed. Therefore, the valve 10 does not reach the closed position at the moment when the door 5 is closed. Then, when the door 5 is in a state of being closed, the valve 10 is further rotated by the urging force of the spring member 22 to reach the closed position.

As shown in FIG. 2, the spring member 22 and the damper 23 are disposed in parallel. In addition, the spring member 22 is connected to the valve 10 at a portion near the rotation shaft 10a that is a rotation center of the valve 10, and the damper 23 is connected to the valve 10 at a portion away from the rotation shaft 10a. When the damper 23 is provided at a position away from the rotating shaft 10a, the valve 10 rotates more slowly to the closed position when the door 5 is closing.

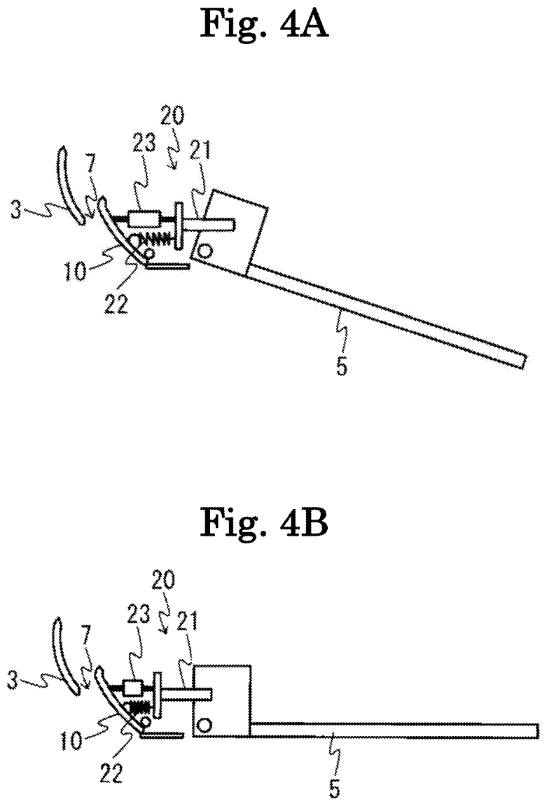

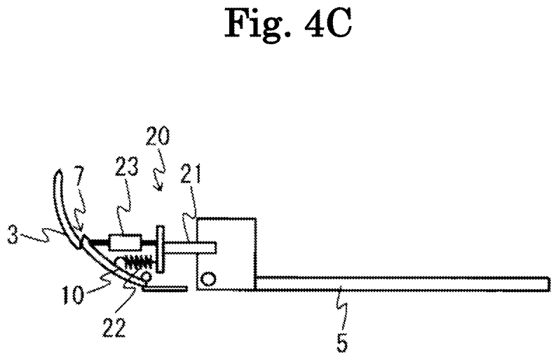

Hereinafter, the state of the valve 10 when the door 5 is closing will be described with reference to FIG. 4A to FIG. 4C.

FIG. 4A to FIG. 4A are schematic diagrams illustrating the state of the valve 10 when the door 5 is closing. Here, it is assumed that the door 5 is opened as shown in FIG. 4A. At this time, the valve 10 is at the open position, and the discharge port 7 is open.

Next, the occupant closes the opened door 5. As the door 5 is closing, the valve 10 at the open position rotates to the closed position. Then, at the moment when the door 5 is closed, as shown in FIG. 4B, the urging force of the spring member 22 is damped by the damper 23 in the valve 10, so that a state where the valve 10 does not reach the closed position and the discharge port 7 is open is maintained. Accordingly, at the moment when the door 5 is closed, the air in the vehicle cabin is discharged from the discharge port 7 so that the pressure in the vehicle cabin space can be reduced. Since the valve 10 is urged by the spring member 22 when the air is discharged, it is possible to prevent the spring member 22 from fluttering.

Then, since the valve 10 is urged by the spring member 22, the valve 10 is further rotated to the closed position as shown in FIG. 4C. That is, when the door 5 is closing, the valve 10 is rotated to the closed position after a time lag from a moment of the door 5 just being closed, and the discharge port 7 is closed.

### Effect of Present Embodiment

In the above embodiment, the valve 10 opening or closing the discharge port 7 rotates between the open position and the closed position with the opening and closing of the door 5 by the rotation mechanism 20. Further, the rotation mechanism 20 does not bring the valve 10 being rotated from the open position to the closed position at the moment when the door 5 is closed, and further rotates the valve 10 to the closed position when the door 5 is in a state of being closed.

According to the above configuration, the valve 10 is not at the closed position at the moment when the door 5 is closed, so that the discharge port 7 is not closed by the valve 10, and the air in the vehicle cabin is discharged from the discharge port 7 to the outside of the vehicle. Accordingly, at the moment when the door 5 is closed, the pressure in the vehicle cabin space can be prevented from increasing, and when the door 5 is in a state of being closed, the discharge port 7 is closed by the valve 10. Therefore, abnormal noise can be prevented from entering the vehicle cabin via the discharge port 7.

In the above description, the rotation mechanism 20 uses the spring member 22 and the damper 23 to damp the urging force acting on the valve 10, but the present disclosure is not limited thereto. The rotation mechanism 20 may have another configuration as long as the valve 10 rotates after a time lag from a moment of the door 5 just being closed.

The present disclosure has been described using the embodiment, but the technical scope of the present disclosure is not limited to the scope described in the above-described embodiment, and various modifications and changes can be made within the scope thereof. For example, a specific embodiment of distributing and integrating devices is not limited to the above embodiment, and all or a part thereof may be configured to be functionally or physically distributed and integrated in any unit. New embodiments generated from any combination of a plurality of embodiments are also included in embodiments of the present disclosure. Effects of the new embodiments generated from the combinations include effects of the original embodiments.

The present application is based on the Japanese Patent Application (P2017-116628) filed on Jun. 14, 2017, contents of which are incorporated herein by reference.

### INDUSTRIAL APPLICABILITY

The vehicle according to the present disclosure is useful in terms of preventing abnormal noise from entering the vehicle cabin via the discharge port for pressure reduction of the vehicle cabin space.

### LIST OF REFERENCE NUMERALS

1 vehicle
3 cabin
5 door
7 discharge port
10 valve
20 rotation mechanism
21 link member
22 spring member
23 damper

1. A vehicle comprising:
an openable door;
a discharge port configured to communicate a vehicle cabin space with an outside, and to discharge air in a vehicle cabin to the outside;
a valve provided at the discharge port and rotatable between an open position for opening the discharge port and a closed position for closing the discharge port; and
a rotation mechanism coupling the door with the valve, configured to rotate the valve from the closed position to the open position when the door is opening, and configured to rotate the valve from the open position to the closed position when the door is closing,
wherein the rotation mechanism does not bring the valve being rotated from the open position to the closed position at a moment when the door is closed, and further rotates the valve to the closed position when the door is in a state of being closed.

2. The vehicle according to claim 1,
wherein the valve is rotated from the open position to the closed position by an urging force,
the rotation mechanism includes a damping member connected to the valve and configured to damp the urging force, and
the damping member rotates, when the door is closing, the valve from the open position to the closed position after a time lag from a moment of the door just being closed.

3. The vehicle according to claim 2,
wherein the rotation mechanism includes an urging member configured to generate the urging force acting on the valve, and
the urging member is connected to the valve at a portion near a rotation center of the valve, and the damping member is connected to the valve at a portion away from the rotation center of the valve.

4. The vehicle according to claim 2 or 3,
wherein the rotation mechanism includes a link member coupling the damping member with the door, and configured to move straight along a longitudinal direction of the damping member when the door is opening or closing to adjust a distance from the valve.
